(19) United States
(12) Patent Application Publication
(10) Pub. No.: US 2025/0086040 A1
(43) Pub. Date: Mar. 13, 2025

(54) AUTOMATIC COLLECTION OF RELEVANT LOGS ASSOCIATED WITH A SERVICE DISRUPTION

(71) Applicant: MICROSOFT TECHNOLOGY LICENSING, LLC, Redmond, WA (US)

(72) Inventor: Navjot SINGH, Patiala (IN)

(21) Appl. No.: 18/465,721

(22) Filed: Sep. 12, 2023

(51) Int. Cl. G06F 11/07

(52) U.S. Cl. CPC G06F 11/0766; G06F 11/0709; G06F 11/079

(57) ABSTRACT

The techniques disclosed herein implement a log collector module that monitors geographically dispersed components in a distributed network for an event that disrupts the normal operation of a service. The distributed network can include a 5G network. In response to determining that the event has occurred, the log collector module triggers the collection of logs related to metrics associated with the event. The logs that are collected include an increased level of verbosity compared to logs that are collected during the normal operation of the service. This enables a cloud service provider to ensure that the root-cause analysis required by service level agreements can be effectively performed. To address the technical challenge imposed by resource constraints, the log collector module only collects the more verbose logs for a predefined time period. Upon expiration of the predefined time period, the collection of the more verbose logs is halted to conserve resources.

### BACKGROUND

As cloud computing rapidly gains popularity, more and more data and/or services are stored and/or provided online via network connections. Providing an optimal and reliable user experience is an important aspect for cloud service providers that offer services via cloud platforms (e.g., AMAZON WEB SERVICES, GOOGLE CLOUD PLATFORM, MICROSOFT AZURE). A cloud service provider is the operator of a cloud platform. A tenant is a customer of the cloud service provider that uses a cloud platform to host a service. Thus, in many examples, the service belongs to a tenant and provision of the service to thousands or millions of end users geographically dispersed around a country, or even the world, is enabled via different resources operated by the cloud service provider (e.g., server farms hosted in various datacenters).

In addition to the resources it operates in datacenters, a cloud service provider typically deploys and/or has access to resources at geographic locations external to the datacenters in order to provide the service. In a scenario where the end users are using mobile devices (e.g., smartphones, tablets) to perform wireless communications, these resources include components deployed in conjunction with infrastructure of a mobile operator network. For example, a mobile operator network includes infrastructure to implement radio access networks (RANs) and a core network (e.g., a 5G network, a 4G LTE network). The RANs can be configured as edge networks and connect various mobile devices to the core network. Therefore, the infrastructure includes stand-alone base stations (e.g., gNodeBs) configured to provide the service to mobile devices within different local geographical areas. In addition, a base station possesses an individual set of resources (e.g., computing resources, transmission resources, cooling resources, power resources) to enable the base station to process and transmit its own signal to and from the mobile devices and to communicate data payloads to and/or from the core network. The infrastructure is configured to support core network components such as the Session Management Function (SMF) component, the Uninterrupted Power Supply (UPS) component, the Access and Mobility Management Function (AMF) component, the Mobility Management Entity (MME) component, and so forth.

To deliver a service to end users, a cloud service provider is tasked with receiving and/or providing data using different networks (e.g., a RAN, a core network, a private data network). These different networks are collectively referred to herein as a distributed network. Unfortunately, due to the distributed nature of the networks used to provide the service, a large number of different types of events can cause disruptions to the service. For example, data traffic within the distributed network can fluctuate dramatically due to the mobile nature of network users. Accordingly, an event may be indicative of the distributed network experiencing a short-lived spike in data traffic causing a disruption to the service in a particular geographic location (e.g., data packets cannot be delivered). In another example, an event may be indicative of a piece of hardware failing (e.g., due to an external factor such as the weather) and this can cause a disruption to the service within a particular geographic location. In yet another example, an event may be indicative of a piece of hardware being unexpectedly taken offline for maintenance and/or updates. In a further example, an event may be indicative of a recent update to software and/or firmware having a bug causing an interruption to the service.

Due to various service level agreements (SLAs) the cloud service provider has with different tenants, the cloud service provider is often required to perform root-cause analysis when a tenant's service experiences an event that degrades the user experience. Stated alternatively, the cloud service provider is often tasked with implementing a debugging process to identify the reasons for the disruption and resolve the disruption.

In order to perform the root-cause analysis, conventional techniques generate logs that capture the state of the data communications. Unfortunately, monitoring for disruptions to the service and collecting logs is a resource-intensive task. Consequently, the log collection is focused on a limited number of metrics being monitored via a single component in the distributed network. Additionally, to reduce the amount of resources used to generate the logs, the conventional techniques limit the level of verbosity in the logs. Stated alternatively, the amount of textual description regarding the state of the data communications at a single component in the distributed network, as captured in a limited number of logs, is below a level that is desired or preferred by engineering teams of the cloud service provider tasked with performing the root-cause analysis. Even further, the conventional techniques limit the collection of the logs to peak hours (e.g., log collection focuses on daytime hours and not nighttime hours). Consequently, the typical logs collected are practically useless when performing the root-cause analysis (e.g., there are not enough logs, the logs that actually are collected do not contain enough information, and the collection of logs avoid odd hours that occur in the middle of the night for example).

Furthermore, the logs are collected by entities other than the cloud service provider (e.g., mobile network operators such as VERIZON and T-MOBILE, third-party open source monitoring technologies such as JAEGAR and the ELK STACK). These logs are often not made available to the cloud service provider in a timely manner due to technical reasons, security reasons, and/or privacy reasons. For example, due to privacy requirements like the General Data Protection Regulation (GDPR) and the California Consumer Privacy Act (CCPA), mobile network operators are unable to share real-time, streamed access to their logs with the engineering teams of the cloud service provider.

Consequently, whenever a disruption occurs in the parts of the distributed network external to the data network and/or the datacenters operated by the cloud service provider, a site engineer for the cloud service provider is notified of the disruption after a substantial time delay. The site engineer then initiates an offline process to manually scrape stale logs that are made available and to provide these stale logs to the engineering teams of the cloud service provider to perform the root-cause analysis. Due to the staleness of the limited number of logs, the inability to collect logs at odd hours and during short-lived disruptions, and the lack of verbosity in the logs, the aforementioned engineering teams have a difficult time correlating relevant data points across the logs and performing a comprehensive root-cause analysis. It is with respect to these and other considerations that the disclosure made herein is presented.

### SUMMARY

The techniques disclosed herein implement a log collector module that addresses the technical challenges described above. The log collector module is configured to monitor various components that are geographically dispersed in a distributed network for an event that disrupts the normal operation of a cloud service provided via the distributed network. The components can include hardware and/or software that is configured and/or operated by the cloud service provider. Alternatively, the components can include hardware and/or software that is configured and/or operated by an entity other than the cloud service provider (e.g., a mobile network operator) and the log collector module, with the necessary authorization, can access these components via application programming interfaces (APIs).

An event that disrupts the normal operation of the cloud service is a technical deficiency (e.g., a change of state in software, hardware, firmware) that causes a degraded user experience. In various examples, the log collector module monitors for and detects an event based on an identifier (e.g., a code) for a specific type of error or a specific type of alert being generated and/or communicated. In one example, the log collector module is configured to poll the components of the distributed network over time (e.g., on a periodic basis such as every minute, every five minutes) to determine whether an event has occurred. To avoid false positives and to ensure that there is actually an issue that needs to be resolved, the log collector module can determine that the event has occurred based on the identifier being detected at least a predefined number of times (e.g., one hundred) in a predefined time window (e.g., one minute).

In response to determining that the event that disrupts the normal operation of the cloud service provided via the distributed network has occurred, the log collector module triggers the collection of a group of logs. A log is a record of values associated with a particular metric that serves as a health indicator for the service (e.g., temperature of a hardware element, central processing unit (CPU) usage or available capacity, incoming requests, available storage capacity, latency). Accordingly, the group of logs relates to a group of metrics associated with the event that disrupts the normal operation of the cloud service. In addition to the values over a period of time, these metrics can include metadata that provides enhanced details about the disruption to the service (e.g., a severity level, an identifier of a geographic area, an identifier of a specific piece of equipment).

In various examples, the metrics to be logged are identified based on a type of event (e.g., an identifier of a specific error or a specific alert) that disrupts the normal operation of the cloud service. That is, the log collector module can access a table with a predefined mapping between the type of the event and the metrics that are relevant to determining a cause for the type of the event. Accordingly, a first type of event may be mapped to a first set of metrics while a second type of event may be mapped to a second, different set of metrics.

The logs that are collected by the log collector module in response to an event that needs to be debugged include an increased level of verbosity compared to logs, related to the same group of metrics, that are collected during the normal operation of the cloud service provided via the distributed network. An increased level of verbosity means that the logs collected in response to an event include more textual description and/or more details associated with the metric being logged compared to the logs that are collected during the normal operation of the cloud service provided via the distributed network. For example, the increased verbosity can include the aforementioned metadata (e.g., a severity level, an identifier of a geographic area, an identifier of a specific piece of equipment). Logs with the increased level of verbosity enable the cloud service provider to ensure that the root-cause analysis required by service level agreements (SLAs) can be performed, and thus, the end user experience is improved and the tenant that hosts the service via the cloud service provider is satisfied.

To address the technical challenge imposed by resource constraints on log collection, the log collector module only collects the more verbose logs for a predefined period of time. Accordingly, upon expiration of the predefined period of time, the log collector module halts the collection of the more verbose logs to conserve resources. In various examples, the predefined time period is identified based on a type of event that disrupts the normal operation of the cloud service. That is, the log collector module can access a table with a predefined mapping between the type of the event and the predefined time period that is required to ensure that a cause for the type of the event can be determined. Accordingly, a first type of event may be mapped to a first predefined time period while a second type of event may be mapped to a second, different predefined time period.

After the more verbose logs have been collected for a predefined period of time, the log collector module is further configured to parse the logs to produce a report that correlates abnormal data values across the group of metrics based on time. An abnormal data point is one that falls outside a range of normal, or expected, data values. For example, if the event is associated with a particular error code associated with an application in the infrastructure layer of the distributed network being unable to deliver messages, and the particular error code is associated with a timestamp or timeframe, the parsing implemented by the log collector module may reveal that disk write errors or elevated CPU usage associated with the same timestamp or timeframe also occurred. In some instances where the metrics are being logged at components distributed across time zones, the log collector module can synchronize varying standards used to capture time (e.g., synchronize between a Coordinated Universal Time (UTC) timestamp and a local time such Pacific Standard Time (PST)).

The log collector module then generates a log bundle that contains the more verbose logs and the report and provides the log bundle to the appropriate engineering team of the cloud service provider. The log bundle enables improved performance of the root-cause analysis associated with the event because the engineering team of the cloud service provider is provided with all the relevant logs in a timely manner. This expands the amount of information available to the engineering team and improves the way in which the information can be accessed, as the engineering team no longer has to deal with a limited number of logs that are stale and that lack the desired verbosity. Stated alternatively, the more verbose logs and the report enable the engineering team to see a more comprehensive picture of the event, even if the event is short-lived and/or occurs at a remote location during odd hours (e.g., the middle of the night local time for the remote location). Consequently, in accordance with a service level agreement (SLA), the cloud service provider can efficiently provide detailed answers to a tenant as to why a service disruptions occurs.

In additional examples, the log collector module is configured to trigger the capturing of data packets at the components to surface header data and payload data associated with the event. For instance, the log collector module can collect data packets via Packet Capture (PCAP), which is a file format used to store network packet data captured from network interfaces. Files in the PCAP format contain the raw data of network packets, including the header data and the payload data. These data packets can be provided to the engineering team as part of the bundle. Similar to the more verbose logging, the packet capture is only implemented for a predefined time period to conserve resources (e.g., packet capture is a resource-intensive task). In a scenario where the log collector module is configured to trigger the capturing of data packets, the log collector module may also mask user information included in the logs and/or in the header data and/or the payload data for data privacy purposes. Masking the user information includes modifying the data so that personal (e.g., sensitive) information is replaced with random information. This will ensure compliance with privacy requirements like the General Data Protection Regulation (GDPR) and the California Consumer Privacy Act (CCPA).

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an environment in which a system that includes a log collector module can monitor various distributed network components for an event that disrupts the normal operation of a cloud service and can provide more verbose logs and a report as part of a bundle to an engineering team so that more effective and efficient root-cause an analysis can be performed.

FIG. 2 is a diagram that captures predefined mappings the log collector module can use to implement the more verbose logging in response to a detected event.

FIG. 3 is a diagram that captures how detected errors or alerts qualify to the level of an event that needs to be debugged.

FIG. 4 is a diagram that illustrates how packet capture can enhance the bundle that is provided to the engineering team.

FIG. 5 is a flow diagram showing aspects of a process for improving performance of root-cause analysis associated with an event that disrupts normal operation of a cloud service provided via a distributed network that includes a radio access network and a core network.

FIG. 6 is a computer architecture diagram illustrating an illustrative computer hardware and software architecture for a computing system capable of implementing aspects of the techniques and technologies presented herein.

FIG. 7 is a diagram illustrating a distributed computing environment capable of implementing aspects of the techniques and technologies presented herein.

### DETAILED DESCRIPTION

The techniques discussed herein implement a log collector module is configured to monitor various components, that are geographically dispersed in a distributed network, for an event that disrupts the normal operation of a cloud service provided via the distributed network. In response to determining that the event has occurred, the log collector module triggers the collection of a group of logs related to a group of metrics associated with the event. The logs that are collected include an increased level of verbosity compared to logs, related to the same group of metrics, that are collected during the normal operation of the cloud service provided via the distributed network. This enables the cloud service provider to ensure that the root-cause analysis required by service level agreements (SLAs) can be performed, and thus, the end user experience is improved and the tenant that hosts the service via the cloud service provider is satisfied. To address the technical challenge imposed by resource constraints on log collection, the log collector module only collects the more verbose logs for a predefined period of time. Accordingly, upon expiration of the predefined period of time, the log collector module halts the collection of the more verbose logs to conserve resources.

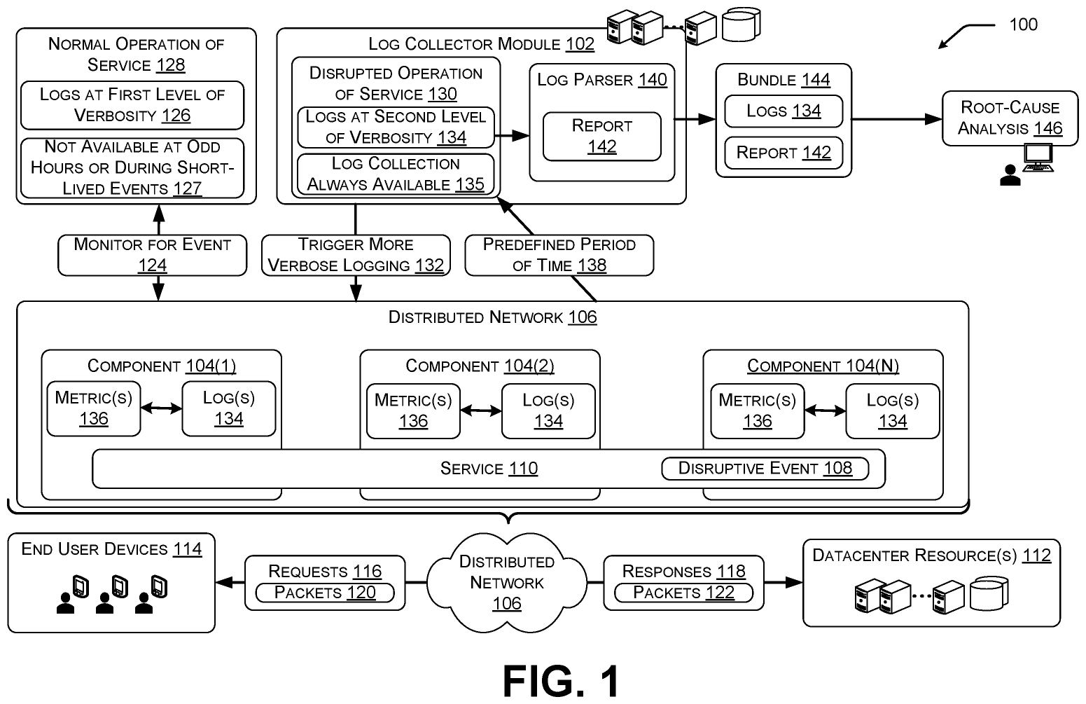

Various examples, scenarios, and aspects that implement the log collector module are described below with respect to FIGS. 1-7.

FIG. 1 illustrates an environment 100 in which a system that includes a log collector module 102 can monitor various components 104(1-N) of a distributed network 106 for an event 108 that disrupts the normal operation of a cloud service 110. The log collector module 102 is implemented by a cloud service provider that operates a cloud platform that includes datacenter resources 112 (e.g., processing resources, memory resources, networking resources, virtual machines, containers). A tenant is a customer of the cloud service provider that uses a cloud platform to host the service 110. Thus, the service 110 belongs to a tenant and provision of the service 110 to thousands or millions of end users, or end user devices 114 that are geographically dispersed around a country or even the world, is enabled via the datacenter resources 112 and the components 104(1-N).

The components 104(1-N) are deployed in conjunction with infrastructure of a mobile operator network. A mobile operator network includes infrastructure to implement radio access networks (RANs) and a core network (e.g., a 5G network, a 4G LTE network). The RANs connect various mobile end user devices 114 to the core network. Therefore, the infrastructure includes stand-alone base stations (e.g., gNodeBs) configured to provide the service 110 to mobile end user devices 114 within different local geographical areas. In addition, a base station possesses an individual set of resources (e.g., computing resources, transmission resources, cooling resources, power resources) to enable the base station to process and transmit its own signal to and from the mobile end user devices 114 and to communicate data payloads to and/or from the core network.

To deliver the service 110 to the mobile end user devices 114, the cloud service provider is tasked with receiving and/or providing data using different networks (e.g., a RAN, a core network, a private data network). These different networks are collectively referred to herein as the distributed network 106. Consequently, the components 104(1-N) can include the Session Management Function (SMF) component, the Uninterrupted Power Supply (UPS) component, the Access and Mobility Management Function (AMF) component, the Mobility Management Entity (MME) component, and so forth. The components 104(1-N) can include hardware and/or software that is configured and/or operated by the cloud service provider. Alternatively, the components can include hardware and/or software 104(1-N) that is configured and/or operated by an entity other than the cloud service provider (e.g., a mobile network operator) and the log collector module 102, with the necessary authorization, can access these components 104(1-N) via application programming interfaces (APIs).

The distributed network 106 processes requests 116 associated with the service 110 from the end user devices 114, which are directed to the datacenter resources 112. Moreover, the distributed network 106 processes responses 118 associated with the service 110 from the datacenter resources 112, which are directed to the end user devices 114. Consequently, the distributed network is configured to communicate data packets 120 associated with the requests 116, as well as data packets 122 associated with the responses 118.

An event 108 that disrupts the normal operation of the cloud service is a technical deficiency (e.g., a change of state in software, hardware, firmware) that causes a degraded user experience. In various examples, the log collector module 102 implements a monitoring procedure 124 to determine if an event 108 has occurred. For example, the log collector module 102 can monitor 116 for an identifier (e.g., a code) of a specific type of error or a specific type of alert that generated and/or communicated within the distributed network. The identifier is indicative of the event 108. The monitoring 124 can include polling the components 104(1-N) of the distributed network 106 over time (e.g., on a periodic basis such as every minute, every five minutes) to determine whether an event 108 has occurred.

As described above, logs 126 conventionally collected during normal operation of the service 128 are made available to the cloud service provider for root-cause analysis. However, this conventional log collection is focused on a limited number of metrics being monitored via a single component in the distributed network 106. Additionally, to reduce the amount of resources used to generate the logs, the conventional logging techniques limit the level of verbosity in the logs. Accordingly, FIG. 1 illustrates that the logs 126 have a “first level of verbosity”. Furthermore, the logs 126 collected during normal operation of the service 128 are limited to longer events that occur during peak hours. Therefore, FIG. 1 illustrates that the logs 126 collected are not available at odd hours (e.g., nighttime hours) or during short-lived events 127. A short-lived event is one that resolves itself within a threshold period of time (e.g., one hour). Consequently, the typical logs 126 collected during normal operation of the service 128 are practically useless when performing the root-cause analysis.

In response to determining that the event 108 that disrupts the normal operation of the cloud service 110 has occurred causing a state of disrupted operation of the service 130, the log collector module 102 triggers 132 the collection of a group of logs 134 that have a second level of verbosity that is greater than the first level of verbosity, referred to herein as expanded logging. Hence, the logs 134 collected during, or in response to, the disrupted operation of the service 130 are more verbose when compared to the logs 126 collected during normal operation of the service. Furthermore, the log collector module 102 is persistently executed so that log collection for an event is always available 135 (e.g., during odd hours and for short-lived events).

The logs 134 are records of values associated with metrics that serve as a health indicator for the service 110 (e.g., temperature of a hardware element, CPU usage or available capacity, incoming requests, available storage capacity, latency). To provide a more comprehensive picture of the disruptive event 108, these logs 134 are collected for metrics 136 at different components 104(1-N) at different geographic locations in the distributed network 106. In addition to the values, these metrics 136 can include metadata that provides enhanced details about the disruption to the service 110 (e.g., a severity level, an identifier of a geographic area, an identifier of a specific piece of equipment). An increased level of verbosity means that the logs 134 collected in response to an event 108 include more textual description and/or more details associated with the metrics 136 being logged compared to the logs 126 that are collected during the normal operation of the service 128. For example, the increased verbosity can include the aforementioned metadata.

To address the technical challenge imposed by resource constraints on log collection, the log collector module 102 only collects the logs 134 for a predefined period of time 138. Accordingly, upon expiration of the predefined period of time 138, the log collector module 102 halts the collection of the more verbose logs 134 to conserve resources.

After the more verbose logs 134 have been collected for a predefined period of time 138, the log collector module 102 is configured to implement a log parser 140 to parse the logs 134 and to produce a report 142 that correlates abnormal data values across the metrics 136 based on time. An abnormal data point is one that falls outside a range of normal, or expected, data values. For example, if the event 108 is associated with a particular error code associated with an application in the infrastructure layer of the distributed network 106 being unable to deliver messages, and the particular error code is associated with a timestamp or timeframe, the parsing implemented by the log parser 140 may reveal that disk write errors or elevated CPU usage associated with the same timestamp or timeframe also occurred. In some instances where the metrics 136 are being logged at components distributed across time zones, the log parser 140 can synchronize varying standards used to capture time (e.g., synchronize between a Coordinated Universal Time (UTC) timestamp and a local time such Pacific Standard Time (PST)).

The log collector module 102 then generates a bundle 144 that contains the more verbose logs 134 and the report 142 and provides the bundle 144 to the appropriate engineering team of the cloud service provider. The bundle 144 enables improved performance of the root-cause analysis 146 associated with the event 108 because the engineering team of the cloud service provider is provided with all the relevant logs in a timely manner. This expands the amount of information available to the engineering team and improves the way in which the information can be accessed, as the engineering team no longer has to deal with a limited number of logs that are stale and that lack the desired verbosity. Stated alternatively, the more verbose logs 134 and the report 142 enable the engineering team to see a more comprehensive picture of the event 108. Consequently, in accordance with a service level agreement (SLA), the cloud service provider can efficiently provide detailed answers to a tenant as to why a service disruptions occurs.

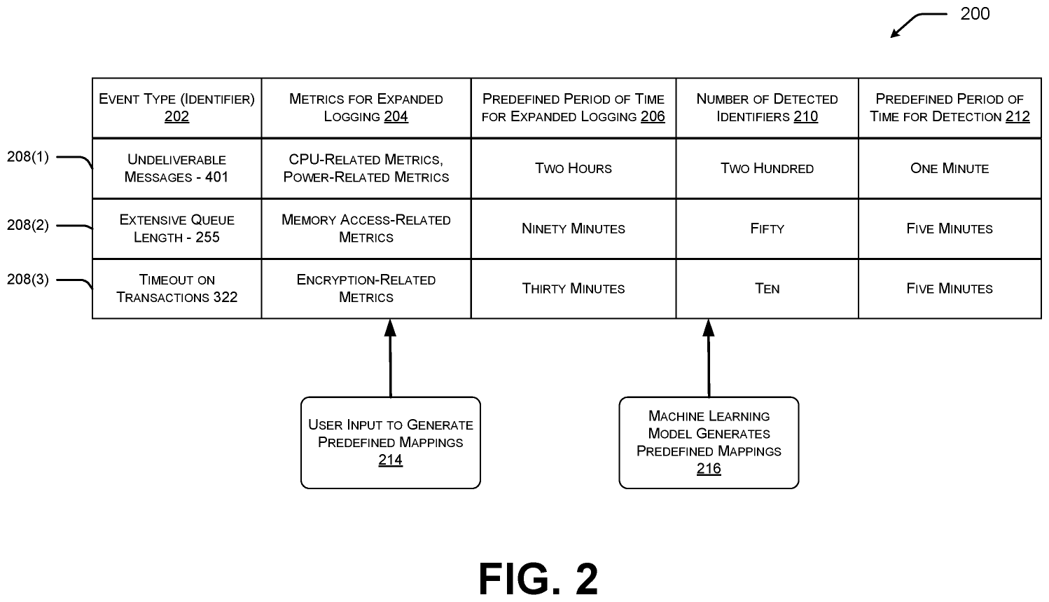

FIG. 2 is a diagram that captures predefined mappings the log collector module 102 can use to implement the more verbose logging in response to a detected event. That is, the metrics 136 to be logged in a more verbose manner can be identified, using a predefined mapping, based on a type of event (e.g., an identifier of a specific error or a specific alert) that disrupts the normal operation of the service 110. Furthermore, the predefined time period can be identified, using a predefined mapping, based on the type of event that disrupts the normal operation of the service 110. To this end, the log collector module 102 is configured to store and access a table 200 with predefined mappings (i.e., the rows) between the type of the event and the metrics that are relevant to determining a cause for the type of the event, as well as the predefined time frame that enables a suitable amount of data collection to determine a cause for the type of the event.

The table 200 includes a first column 202 that indicates an event type. In various examples, the event types can be different identifiers (e.g., codes) of specific errors or alerts. The table 200 includes a second column 204 that identifies the metrics for the expanded logging (i.e., more verbose logging) that are known to be relevant to determining a cause for the type of the event. The table 200 includes a third column 206 that identifies the predefined time frame for the expanded logging that enables a suitable amount of data collection to determine a cause for the type of the event.

The table entries discussed below are provided as examples only, and thus the identifiers, the number of metrics identified for expanded logging, and the predefined period of time for expanded logging may be simplified for ease of discussion. A first predefined mapping 208(1) reflects that identifier “401” for “Undeliverable Messages” is associated with “CPU-related metrics” and “Power-related metrics” and that the expanded logging of these metrics is to be implemented for two hours. A second predefined mapping 208(2) reflects that identifier “255” for “Extensive Queue Length” is associated with “Memory Access-related metrics” and that the expanded logging of these metrics is to be implemented for ninety minutes. A third predefined mapping 208(3) reflects that identifier “322” for “Timeout on Transactions” is associated with “Encryption-related metrics” and that the expanded logging of these metrics is to be implemented for thirty minutes.

Accordingly, a first type of event may be mapped to a first set of metrics while a second type of event may be mapped to a second, different set of metrics. Moreover, the first type of event may be mapped to a first predefined time period for expanded logging while a second type of event may be mapped to a second, different predefined time period for expanded logging.

To avoid false positives and to ensure that there is actually an issue that needs to be resolved, the table 200 can include another column 210 that identifies a predefined number of times the identifier for the event type must be generated and/or detected to elevate the identifier to an actual occurrence of an event. Moreover, the table 200 can include another column 212 that identifies a predetermined period of time in which the predefined number of times the identifier for the event type must be generated and/or detected to elevate the identifier to an actual occurrence of an event.

As shown, the identifier “401” representing an “Undeliverable Messages” event type, as captured in predefined mapping 208(1), must be detected two hundred times in one minute for the log collector module 102 to determine an event has occurred. The identifier “255” representing an “Extensive Queue Length” event type, as captured in predefined mapping 208(2), must be detected fifty times in five minutes for the log collector module 102 to determine an event has occurred. The identifier “322” representing a “Timeout on Transactions” event type, as captured in predefined mapping 208(3), must be detected ten times in five minutes for the log collector module 102 to determine an event has occurred.

The predefined mappings may be user defined. For example, the engineering teams can provide input regarding the metrics and predefined time periods needed for improved root-cause analysis of different types of events. Consequently, FIG. 2 illustrates that user input can be provided to generate the predefined mappings 214 in the table 200.

Alternatively, the predefined mappings may be generated using machine learning. For example, data associated with root-cause analysis, as performed for engineering teams, can be input into a machine learning model and the machine learning model can determine the metrics and predefined time periods needed for improved root-cause analysis of different types of events. Moreover, based on feedback received (e.g., when performing the root-cause analysis), the machine learning model can update the metrics and predefined time periods mapped to a type of event. Consequently, FIG. 2 illustrates that a machine learning model can generate the predefined mappings 216 in the table 200.

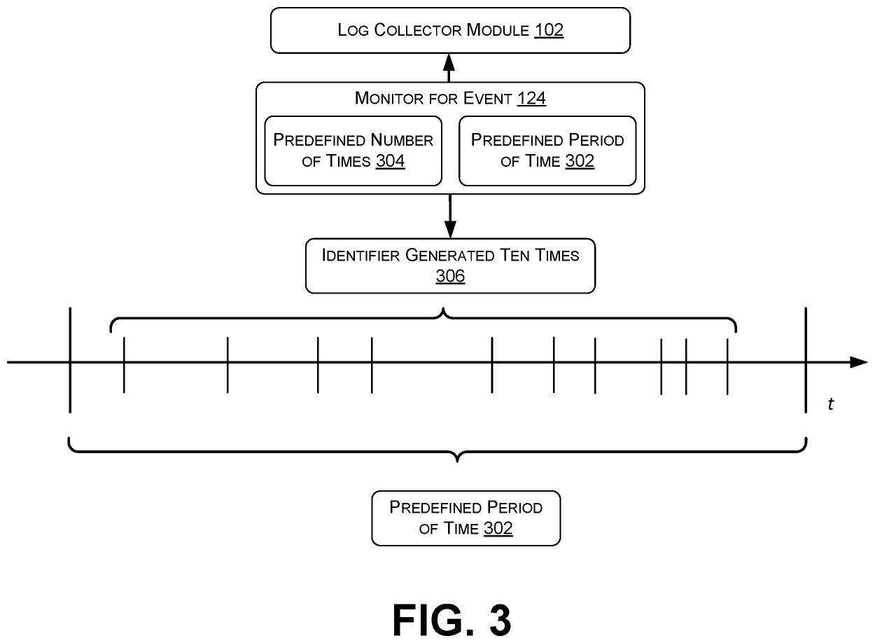

FIG. 3 is a diagram that captures how detected errors or alerts qualify to the level of an event that needs to be debugged. FIG. 3 shows a time, t, axis with marks that carve out a predefined period of time 302. As discussed above with respect to FIG. 1 and FIG. 2, while monitoring 124 for a particular type of an event the log collector module 102 can poll for a predefined number of times 304 an identifier of a specific error or a specific alert is generated in a predefined period of time 302. This helps ensure that there is actually an issue that needs to be resolved. In the example of FIG. 3, the identifier is generated ten times 306 within the predefined time period 302. Consequently, if the predefined number of times 304 is ten or less, then the log collector module 102 determines that an event has occurred.

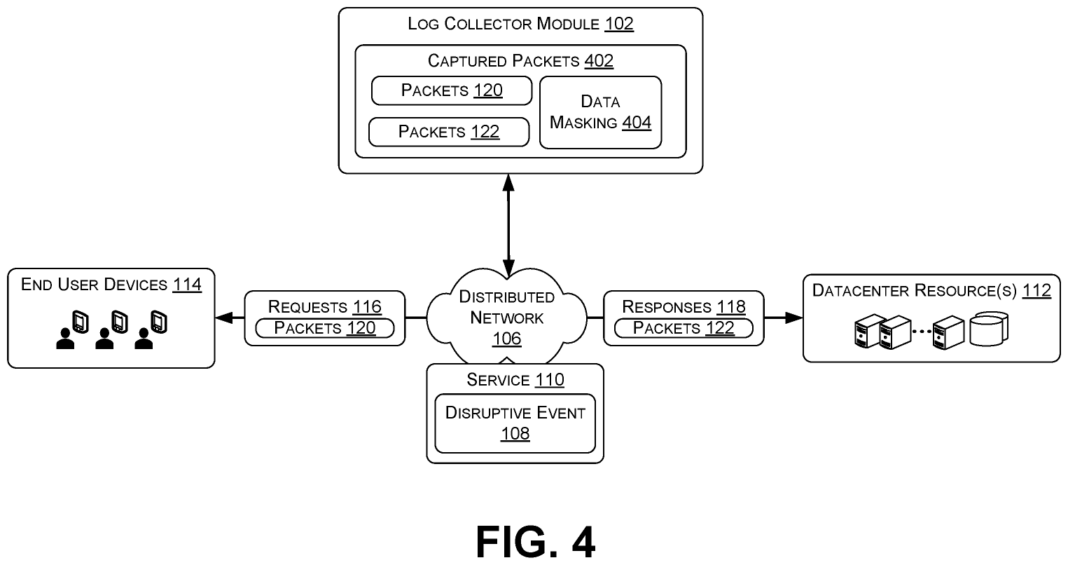

FIG. 4 is a diagram that illustrates how packet capture can enhance the bundle that is provided to the engineering team. As shown in FIG. 4, the log collector module 102 is configured to trigger the capturing of data packets at the components of the distributed network 106 to surface header data and payload data associated with the event 108 that disrupts the service 110 provided via the distributed network 106. Accordingly, the log collector module 102 includes captured packets 402 comprising the packets 120 and 122 communicated during the expanded logging in response to the determination that an event 108 has occurred. For instance, the log collector module 102 can collect the data packets via Packet Capture (PCAP), which is a file format used to store network packet data captured from network interfaces. Files in the PCAP format contain the raw data of network packets, including the header data and the payload data. These data packets can be provided to the engineering team as part of the bundle 144. Similar to the more verbose logging, the packet capture is only implemented for a predefined time period to conserve resources (e.g., packet capture is a resource-intensive task).

In a scenario where the log collector module 102 is configured to trigger the capturing of data packets, the log collector module 102 may also implement a data masking operation 404 to mask user information included in the logs and/or in the header data and/or the payload data for data privacy purposes. Masking the user information includes modifying the data so that personal (e.g., sensitive) information is replaced with random information. This will ensure compliance with privacy requirements like the General Data Protection Regulation (GDPR) and the California Consumer Privacy Act (CCPA).

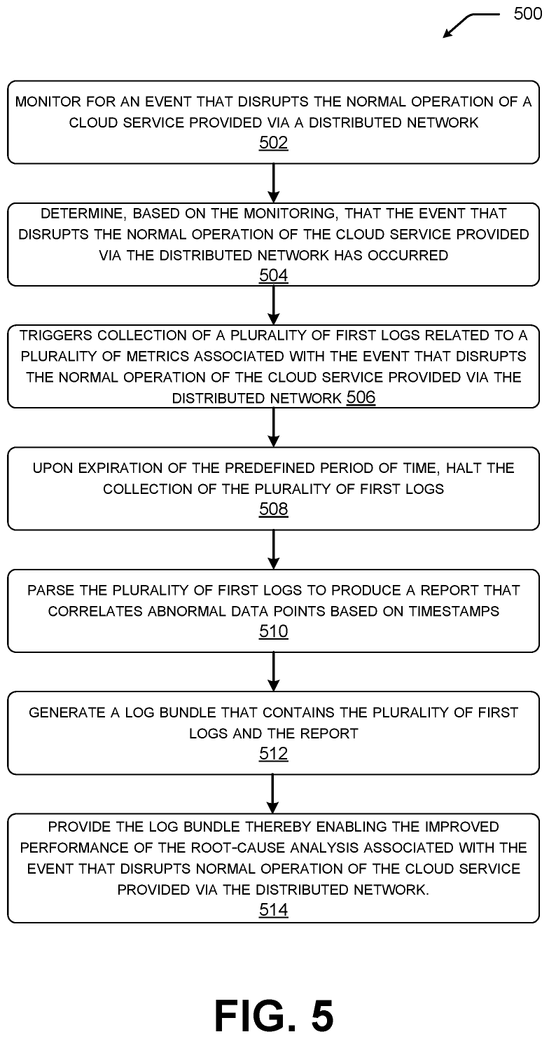

Proceeding to FIG. 5, aspects of a process 500 for improving performance of root-cause analysis associated with an event that disrupts normal operation of a cloud service provided via a distributed network that includes a radio access network and a core network. With reference to FIG. 5, the process 500 begins at operation 502 where the log collector module monitors for the event that disrupts the normal operation of the cloud service provided via the distributed network.

At operation 504, the log collector module determines, based on the monitoring, that the event that disrupts the normal operation of the cloud service provided via the distributed network has occurred.

At operation 506, the log collector module triggers the collection of a plurality of first logs related to a plurality of metrics associated with the event that disrupts the normal operation of the cloud service provided via the distributed network. As described above, the plurality of first logs is collected, for a predefined period of time, from a plurality of distributed network components configured to provide the cloud service at different geographic locations for a predefined period of time. Moreover, the plurality of first logs includes an increased level of verbosity compared to a corresponding plurality of second logs related to the plurality of metrics that is collected during the normal operation of the cloud service provided via the distributed network.

At operation 508, upon expiration of the predefined period of time, the log collector module halts the collection of the plurality of first logs. Then, at operation 510, the log collector module parses the plurality of first logs to produce a report that correlates abnormal data points based on timestamps.

At operation 512, the log collector module generates a log bundle that contains the plurality of first logs and the report. Finally, at operation 514, the log collector module provides the log bundle thereby enabling the improved performance of the root-cause analysis associated with the event that disrupts normal operation of the cloud service provided via the distributed network.

For ease of understanding, the process discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated process can end at any time and need not be performed in their entireties. Some or all operations of the process, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

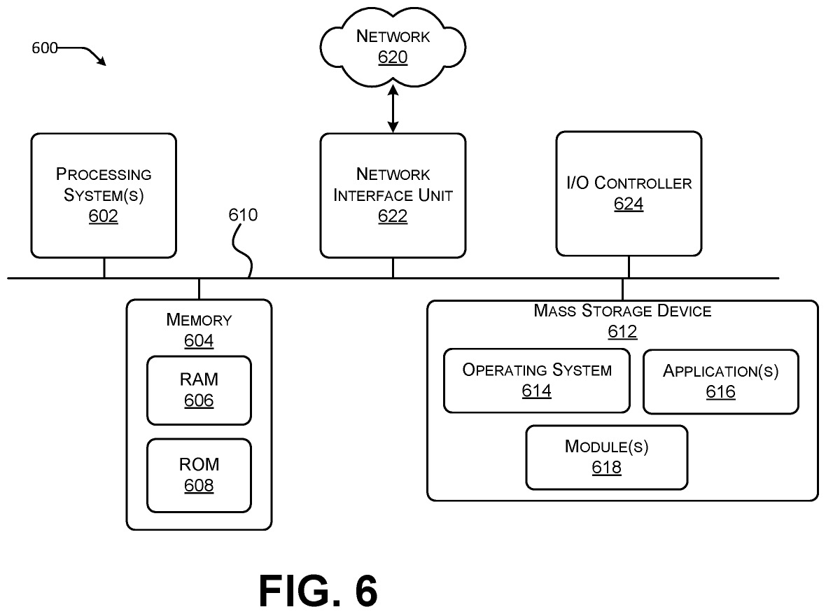

FIG. 6 shows additional details of an example computer architecture 600 for a device, such as a computer or a server configured as part of a cloud system, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location. Moreover, the systems discussed herein can be provided as a distributed computing system such as a cloud/edge service.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

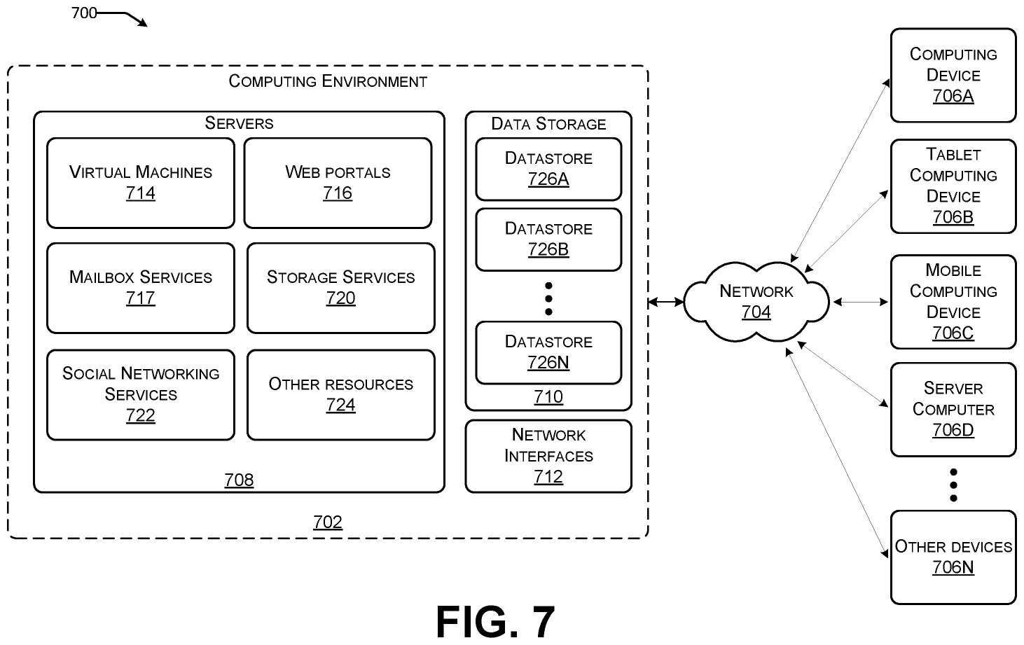

FIG. 7 depicts an illustrative distributed computing environment 700 capable of executing the software components described herein. Thus, the distributed computing environment 700 illustrated in FIG. 7 can be utilized to execute any aspects of the software components presented herein. For example, the distributed computing environment 700 can be utilized to execute aspects of the software components described herein.

Accordingly, the distributed computing environment 700 can include a computing environment 702 operating on, in communication with, or as part of the network 704. The network 704 can include various access networks. One or more client devices 706A-706N (hereinafter referred to collectively and/or generically as “computing devices 706”) can communicate with the computing environment 702 via the network 704. In one illustrated configuration, the computing devices 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of computing devices 706 can communicate with the computing environment 702.

In various examples, the computing environment 702 includes servers 708, data storage 610, and one or more network interfaces 712. The servers 708 can host various services, virtual machines, portals, and/or other resources. In the illustrated configuration, the servers 708 host virtual machines 714, Web portals 716, mailbox services 718, storage services 720, and/or social networking services 722. As shown in FIG. 7 the servers 708 also can host other services, applications, portals, and/or other resources (“other resources”) 724.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more servers configured to host data for the computing environment 700. The data storage 710 can include, host, or provide one or more real or virtual datastores 726A-726N (hereinafter referred to collectively and/or generically as “datastores 726”). The datastores 726 are configured to host data used or created by the servers 808 and/or other data. That is, the datastores 726 also can host or store web page documents, word documents, presentation documents, data structures, algorithms for execution by a recommendation engine, and/or other data utilized by any application program. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects.

The disclosure presented herein also encompasses the subject matter set forth in the following clauses.

Example Clause A, a method for improving performance of root-cause analysis associated with an event 108 that disrupts normal operation of a cloud service provided via a distributed network that includes a radio access network and a 5G network, the method comprising: monitoring for the event that disrupts the normal operation of the cloud service provided via the distributed network; determining, based on the monitoring, that the event that disrupts the normal operation of the cloud service provided via the distributed network has occurred; in response to determining that the event that disrupts the normal operation of the cloud service provided via the distributed network has occurred, triggering collection of a plurality of first logs related to a plurality of metrics associated with the event that disrupts the normal operation of the cloud service provided via the distributed network, wherein: the plurality of first logs is collected for a predefined period of time; the plurality of first logs is collected from a plurality of components, in the distributed network, configured to provide the cloud service at different geographic locations; and the plurality of first logs includes an increased level of verbosity compared to a corresponding plurality of second logs related to the plurality of metrics that is collected during the normal operation of the cloud service provided via the distributed network; upon expiration of the predefined period of time, halting the collection of the plurality of first logs; parsing the plurality of first logs to produce a report that correlates abnormal data points based on timestamps; generating a log bundle that contains the plurality of first logs and the report; and providing the log bundle thereby enabling the improved performance of the root-cause analysis associated with the event that disrupts normal operation of the cloud service provided via the distributed network.

Example Clause B, the method of Example Clause A, further comprising identifying the plurality of metrics based on a predefined mapping of a type of the event that disrupts the normal operation of the cloud service provided via the distributed network to the plurality of metrics.

Example Clause C, the method of Example Clause B, wherein: the predefined mapping is learned via a machine learning model; and the plurality of metrics is updated via the machine learning model.

Example Clause D, the method of Example Clause B, wherein the predefined mapping is user-defined.

Example Clause E, the method of any one of Example Clauses A through D, further comprising identifying the predefined period of time based on a predefined mapping of a type of the event that disrupts the normal operation of the cloud service provided via the distributed network to the predefined period of time.

Example Clause F, the method of Example Clause E, wherein: the predefined mapping is learned via a machine learning model; and the predefined period of time is updated via the machine learning model.

Example Clause G, the method of Example Clause E, wherein the predefined mapping is user-defined.

Example Clause H, the method of any one of Example Clauses A through G, wherein: the event is associated with an identifier of a specific error or a specific alert; and the event that disrupts the normal operation of the cloud service provided via the distributed network is determined to have occurred based on the identifier being detected at least a predefined number of times in another predefined period of time associated with the event.

Example Clause I, the method of any one of Example Clauses A through H, further comprising: capturing data packets at the plurality of components to surface header data and payload data associated with the event; and providing the data packets as part of the bundle.

Example Clause J, the method of Example Clause I, further comprising masking user information in the header data and the payload data for data privacy purposes.

Example Clause K, a system for improving performance of root-cause analysis associated with an event that disrupts normal operation of a cloud service provided via a distributed network that includes a radio access network and a core network, the system comprising: a processing system; and a computer readable medium having encoded thereon computer readable instructions that when executed by the processing system cause the system to perform operations comprising: monitoring for the event that disrupts the normal operation of the cloud service provided via the distributed network; determining, based on the monitoring, that the event that disrupts the normal operation of the cloud service provided via the distributed network has occurred; in response to determining that the event that disrupts the normal operation of the cloud service provided via the distributed network has occurred, triggering collection of a plurality of first logs related to a plurality of metrics associated with the event that disrupts the normal operation of the cloud service provided via the distributed network, wherein: the plurality of first logs is collected for a predefined period of time; the plurality of first logs is collected from a plurality of components, in the distributed network, configured to provide the cloud service at different geographic locations; and the plurality of first logs includes an increased level of verbosity compared to a corresponding plurality of second logs related to the plurality of metrics that is collected during the normal operation of the cloud service provided via the distributed network; upon expiration of the predefined period of time, halting the collection of the plurality of first logs; parsing the plurality of first logs to produce a report that correlates abnormal data points based on timestamps; generating a log bundle that contains the plurality of first logs and the report; and providing the log bundle thereby enabling the improved performance of the root-cause analysis associated with the event that disrupts normal operation of the cloud service provided via the distributed network.

Example Clause L, the system of Example Clause K, wherein the operations further comprise identifying the plurality of metrics based on a predefined mapping of a type of the event that disrupts the normal operation of the cloud service provided via the distributed network to the plurality of metrics.

Example Clause M, the system of Example Clause L, wherein: the predefined mapping is learned via a machine learning model; and the plurality of metrics is updated via the machine learning model.

Example Clause N, the system of any one of Example Clauses K through M, wherein the operations further comprise identifying the predefined period of time based on a predefined mapping of a type of the event that disrupts the normal operation of the cloud service provided via the distributed network to the predefined period of time.

Example Clause O, the system of Example Clause N, wherein: the predefined mapping is learned via a machine learning model; and the predefined period of time is updated via the machine learning model.

Example Clause P, the system of any one of Example Clauses K through O, wherein: the event is associated with an identifier of a specific error or a specific alert; and the event that disrupts the normal operation of the cloud service provided via the distributed network is determined to have occurred based on the identifier being detected at least a predefined number of times in another predefined period of time associated with the event.

Example Clause Q, the system of any one of Example Clauses K through P, wherein the operations further comprise: capturing data packets at the plurality of components to surface header data and payload data associated with the event; and providing the data packets as part of the bundle.

Example Clause R, the system of Example Clause Q, wherein the operations further comprise masking user information in the header data and the payload data for data privacy purposes.

Example Clause S, a computer readable storage medium having encoded thereon computer readable instructions that, when executed by a system, cause the system to perform operations comprising: monitoring for the event that disrupts the normal operation of the cloud service provided via the distributed network; determining, based on the monitoring, that the event that disrupts the normal operation of the cloud service provided via the distributed network has occurred; in response to determining that the event that disrupts the normal operation of the cloud service provided via the distributed network has occurred, triggering collection of a plurality of first logs related to a plurality of metrics associated with the event that disrupts the normal operation of the cloud service provided via the distributed network, wherein: the plurality of first logs is collected for a predefined period of time; the plurality of first logs is collected from a plurality of components, in the distributed network, configured to provide the cloud service at different geographic locations; and the plurality of first logs includes an increased level of verbosity compared to a corresponding plurality of second logs related to the plurality of metrics that is collected during the normal operation of the cloud service provided via the distributed network; upon expiration of the predefined period of time, halting the collection of the plurality of first logs; parsing the plurality of first logs to produce a report that correlates abnormal data points based on timestamps; generating a log bundle that contains the plurality of first logs and the report; and providing the log bundle thereby enabling the improved performance of the root-cause analysis associated with the event that disrupts normal operation of the cloud service provided via the distributed network.

Example Clause T, the computer readable storage medium of Example Clause S, wherein the operations further comprise identifying the plurality of metrics based on a predefined mapping of a type of the event that disrupts the normal operation of the cloud service provided via the distributed network to the plurality of metrics.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different metrics)

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for improving performance of root-cause analysis associated with an event 108 that disrupts normal operation of a cloud service provided via a distributed network that includes a radio access network and a 5G network, the method comprising:
monitoring for the event that disrupts the normal operation of the cloud service provided via the distributed network;
determining, based on the monitoring, that the event that disrupts the normal operation of the cloud service provided via the distributed network has occurred;
in response to determining that the event that disrupts the normal operation of the cloud service provided via the distributed network has occurred, triggering collection of a plurality of first logs related to a plurality of metrics associated with the event that disrupts the normal operation of the cloud service provided via the distributed network, wherein:
the plurality of first logs is collected for a predefined period of time;
the plurality of first logs is collected from a plurality of components, in the distributed network, configured to provide the cloud service at different geographic locations; and
the plurality of first logs includes an increased level of verbosity compared to a corresponding plurality of second logs related to the plurality of metrics that is collected during the normal operation of the cloud service provided via the distributed network;
upon expiration of the predefined period of time, halting the collection of the plurality of first logs;
parsing the plurality of first logs to produce a report that correlates abnormal data points based on timestamps;
generating a log bundle that contains the plurality of first logs and the report; and
providing the log bundle thereby enabling the improved performance of the root-cause analysis associated with the event that disrupts normal operation of the cloud service provided via the distributed network.

2. The method of claim 1, further comprising identifying the plurality of metrics based on a predefined mapping of a type of the event that disrupts the normal operation of the cloud service provided via the distributed network to the plurality of metrics.

3. The method of claim 2, wherein:
the predefined mapping is learned via a machine learning model; and
the plurality of metrics is updated via the machine learning model.

4. The method of claim 2, wherein the predefined mapping is user-defined.

5. The method of claim 1, further comprising identifying the predefined period of time based on a predefined mapping of a type of the event that disrupts the normal operation of the cloud service provided via the distributed network to the predefined period of time.

6. The method of claim 5, wherein:
the predefined mapping is learned via a machine learning model; and
the predefined period of time is updated via the machine learning model.

7. The method of claim 5, wherein the predefined mapping is user-defined.

8. The method of claim 1, wherein:
the event is associated with an identifier of a specific error or a specific alert; and
the event that disrupts the normal operation of the cloud service provided via the distributed network is determined to have occurred based on the identifier being detected at least a predefined number of times in another predefined period of time associated with the event.

9. The method of claim 1, further comprising:
capturing data packets at the plurality of components to surface header data and payload data associated with the event; and
providing the data packets as part of the bundle.

10. The method of claim 9, further comprising masking user information in the header data and the payload data for data privacy purposes.

11. A system for improving performance of root-cause analysis associated with an event that disrupts normal operation of a cloud service provided via a distributed network that includes a radio access network and a core network, the system comprising:
a processing system; and
a computer readable medium having encoded thereon computer readable instructions that when executed by the processing system cause the system to perform operations comprising:
monitoring for the event that disrupts the normal operation of the cloud service provided via the distributed network;
determining, based on the monitoring, that the event that disrupts the normal operation of the cloud service provided via the distributed network has occurred;
in response to determining that the event that disrupts the normal operation of the cloud service provided via the distributed network has occurred, triggering collection of a plurality of first logs related to a plurality of metrics associated with the event that disrupts the normal operation of the cloud service provided via the distributed network, wherein:
the plurality of first logs is collected for a predefined period of time;
the plurality of first logs is collected from a plurality of components, in the distributed network, configured to provide the cloud service at different geographic locations; and
the plurality of first logs includes an increased level of verbosity compared to a corresponding plurality of second logs related to the plurality of metrics that is collected during the normal operation of the cloud service provided via the distributed network;
upon expiration of the predefined period of time, halting the collection of the plurality of first logs;
parsing the plurality of first logs to produce a report that correlates abnormal data points based on timestamps;
generating a log bundle that contains the plurality of first logs and the report; and
providing the log bundle thereby enabling the improved performance of the root-cause analysis associated with the event that disrupts normal operation of the cloud service provided via the distributed network.

12. The system of claim 11, wherein the operations further comprise identifying the plurality of metrics based on a predefined mapping of a type of the event that disrupts the normal operation of the cloud service provided via the distributed network to the plurality of metrics.

13. The system of claim 12, wherein:
the predefined mapping is learned via a machine learning model; and
the plurality of metrics is updated via the machine learning model.

14. The system of claim 11, wherein the operations further comprise identifying the predefined period of time based on a predefined mapping of a type of the event that disrupts the normal operation of the cloud service provided via the distributed network to the predefined period of time.

15. The system of claim 14, wherein:
the predefined mapping is learned via a machine learning model; and
the predefined period of time is updated via the machine learning model.

16. The system of claim 11, wherein:
the event is associated with an identifier of a specific error or a specific alert; and
the event that disrupts the normal operation of the cloud service provided via the distributed network is determined to have occurred based on the identifier being detected at least a predefined number of times in another predefined period of time associated with the event.

17. The system of claim 11, wherein the operations further comprise:
capturing data packets at the plurality of components to surface header data and payload data associated with the event; and
providing the data packets as part of the bundle.

18. The system of claim 17, wherein the operations further comprise masking user information in the header data and the payload data for data privacy purposes.

19. A computer readable storage medium having encoded thereon computer readable instructions that, when executed by a system, cause the system to perform operations comprising:
monitoring for the event that disrupts the normal operation of the cloud service provided via the distributed network;
determining, based on the monitoring, that the event that disrupts the normal operation of the cloud service provided via the distributed network has occurred;
in response to determining that the event that disrupts the normal operation of the cloud service provided via the distributed network has occurred, triggering collection of a plurality of first logs related to a plurality of metrics associated with the event that disrupts the normal operation of the cloud service provided via the distributed network, wherein:
the plurality of first logs is collected for a predefined period of time;
the plurality of first logs is collected from a plurality of components, in the distributed network, configured to provide the cloud service at different geographic locations; and
the plurality of first logs includes an increased level of verbosity compared to a corresponding plurality of second logs related to the plurality of metrics that is collected during the normal operation of the cloud service provided via the distributed network;
upon expiration of the predefined period of time, halting the collection of the plurality of first logs;
parsing the plurality of first logs to produce a report that correlates abnormal data points based on timestamps;
generating a log bundle that contains the plurality of first logs and the report; and
providing the log bundle thereby enabling the improved performance of the root-cause analysis associated with the event that disrupts normal operation of the cloud service provided via the distributed network.

20. The computer readable storage medium of claim 19, wherein the operations further comprise identifying the plurality of metrics based on a predefined mapping of a type of the event that disrupts the normal operation of the cloud service provided via the distributed network to the plurality of metrics.
